(19) United States
(12) Patent Application Publication
(10) Pub. No.: US 2009/0293229 A1
(43) Pub. Date: Dec. 3, 2009

(54) HINGE

(75) Inventor: CHEN-WEI CHIANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/192,087

(22) Filed: Aug. 14, 2008

(30) Foreign Application Priority Data
May 30, 2008 (CN) 200820300956.3

(51) Int. Cl. E05D 11/08

(52) U.S. Cl. 16/342

(57) ABSTRACT

A hinge includes a base, a sleeve and a shaft. The base defines a U-shaped slot. The sleeve includes at least one sleeve part and a U-shaped stand for being tightly received in the U-shaped slot of the base. The shaft includes a spindle for being rotationally received in the at least one sleeve part.

### BACKGROUND

1. Field of the Invention

The present invention generally relates to hinges and, particularly, to a hinge for a foldable electronic device.

2. Description of Related Art

A foldable electronic device including a main body and a display often use a hinge to interconnect the main body and the display, so that the display is rotatable with respect to the main body, and can be folded to the main body for saving space.

A hinge normally includes two pieces fixed to the main body and the display respectively. The two pieces are rotatable relative to each other. For keeping the display at any angle with respect to the main body, a frictional force is provided between the two pieces. However, over time, the fit between all the various pieces may loosen, which may cause unwanted noise and poor performance.

### BRIEF DESCRIPTION OF THE DRAWINGS

FIG. 1 is an assembled, isometric view of a hinge in accordance with an exemplary embodiment.

FIG. 2 is an exploded, isometric view of FIG. 1.

FIG. 3 is a cross-sectional view, taken along the line III-III of FIG. 1.

### DETAILED DESCRIPTION

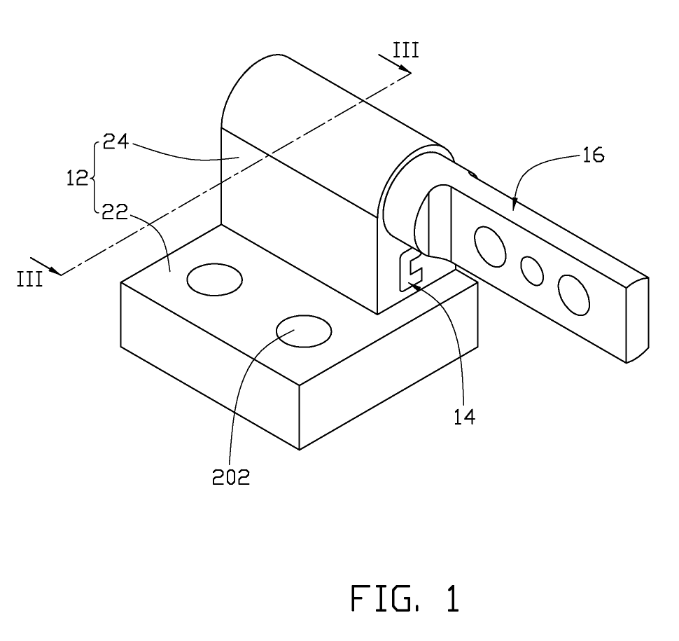

Referring to FIG. 1, a hinge in accordance with an exemplary embodiment includes a base 12, a sleeve 14, and a shaft 16. The sleeve 14 is fixed in the base 12, and the shaft 16 is rotationally received in the sleeve 14, therefore, the shaft 16 is rotatable with respect to the base 12. The base 12 and the shaft 16 are capable of respectively being fixed to two parts of a foldable electronic device, such as a main body and a display, which is to be rotatable relative to the main body.

The base 12 includes a bottom portion 22 and a casing portion 24 extending up from a side of the bottom portion 22. In other embodiments, the casing portion 24 may be a separate part, and fixed on the bottom portion 22. The bottom portion 22 defines two fixing holes 202 at opposite sides thereof, for allowing rivets or screws to extend therethrough, thereby fixing the bottom portion 22 to one part of the electronic device.

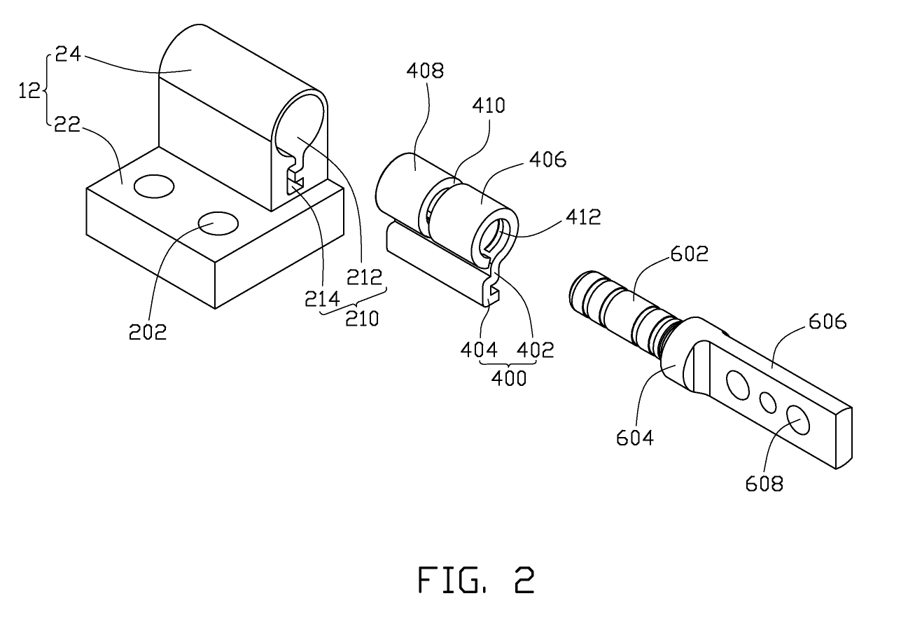

Referring also to FIG. 2, the casing portion 24 defines a receiving space 210 therein, for receiving the sleeve 14. The receiving space 210 includes a circular part 212 in a top of the casing portion 24 and a U-shaped slot 214 connecting a bottom of the circular part 212. Correspondingly, the sleeve 14 includes a U-shaped stand 404 at a bottom, two co-axial sleeve parts 406, 408, and a connecting part 402 connected between the stand 404 and the sleeve parts 406, 408. An opening 410 separates the sleeve parts 406, 408. Generally, the sleeve parts 406, 408 protrude from a top of the connection part 402 and are coiled to form nearly closed circles. The sleeve parts 406, 408 are circularly flexed towards reverse directions, and distal ends thereof further have slight gaps from the position that the sleeve parts 406, 408 are protruded. Therefore, the sleeve parts 406, 408 are generally C-shaped. A groove 412, which can receive lubricant therein, is defined in an inner wall of each of the sleeve parts 406, 408. The stand 404 is shaped to be fittingly received in the slot 214 of the base 12, thus the sleeve 14 can be fixed in the base 12.

The shaft 16 includes a spindle 602 at an end thereof, a fixing portion 606 at an opposite end thereof, and a block 604 connected between the spindle 602 and the fixing portion 606. The spindle 602 is capable of being rotationally received in the sleeve parts 406, 408; therefore the shaft 16 is rotational relative to the base 12 and the sleeve 14. The fixing portion 606 is generally flat, and defines a plurality of fixing holes 608, for allowing rivets or screws to extend therethrough, therefore fixing the shaft 16 to the other part of the electronic device.

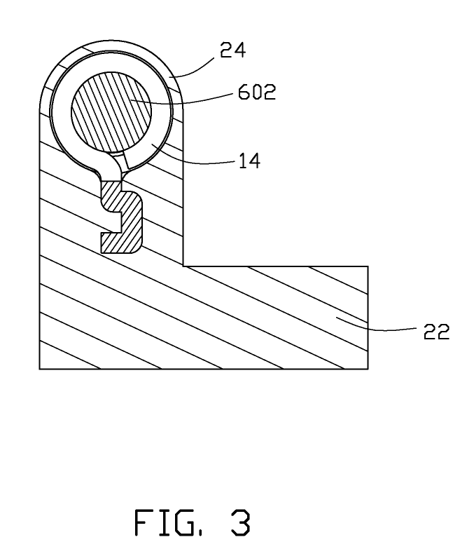

Referring also to FIG. 3, in assembly, the spindle 602 of the shaft 16 is received in the sleeve parts 406, 408 of the sleeve 14, and the sleeve 14 enters the receiving space 210 of the casing portion 24. Therefore, the U-shaped stand 404 of the sleeve 14 is tightly received in the U-shaped slot 214 of the base 12, and the sleeve parts 406, 408 are received in the circular part 212. After the bottom portion 22 of the base 12 and the fixing portion 606 of the shaft 16 are respectively fixed to the two parts of the electronic device, the two parts are rotatable with respect to each other.

The embodiment was chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiment described therein.

What is claimed is:

1. A hinge comprising:
a base defining a U-shaped slot;
a sleeve comprising at least one sleeve part and a U-shaped stand for being tightly received in the U-shaped slot of the base; and
a shaft comprising a spindle for being rotationally received in the at least one sleeve part.

2. The hinge as described in claim 1, wherein the base comprises a bottom portion defining at least one fixing hole for allowing rivets or screws to extend therethrough.

3. The hinge as described in claim 2, wherein the base further comprises a casing portion fixed to the bottom portion, the casing portion defines a received space therein for receiving the sleeve.

4. The hinge as described in claim 3, wherein the receiving space comprises a circular part communicating with the U-shaped slot, the at least one sleeve part is received in the circular part.

5. The hinge as described in claim 4, wherein the sleeve still further comprises a connection part connecting the U-shaped stand and the at least one sleeve part.

6. The hinge as described in claim 5, wherein the at least one sleeve part is nearly a closed circle, and a gap is defined between a distal end of the at least one sleeve part and a position where the connection part conjuncts with the at least one sleeve part.

7. The hinge as described in claim 6, wherein the at least one sleeve part comprises two co-axial sleeve parts separated by an opening.

8. The hinge as described in claim 7, wherein the gap of one of the sleeve part is defined at opposite direction with respect to that of the other sleeve part.

9. The hinge as described in claim 8, wherein distal ends of the sleeve parts have slight gaps from the connection part.

10. The hinge as described in claim 1, wherein the shaft comprises a block for resisting against a side of the at least one sleeve part as the spindle is received in the at least one sleeve part.

11. The hinge as described in claim 10, wherein the shaft further comprises a fixing portion connected to the block and defining at least one fixing hole for allowing rivets or screws to extend therethrough.

12. The hinge as described in claim 11, wherein the spindle and the fixing portion are connected to opposite side of the block.

13. The hinge as described in claim 1, wherein an inner wall of each of the least one sleeve part defines a groove.
